(19) United States
(12) Patent Application Publication
(10) Pub. No.: US 2010/0140530 A1
(43) Pub. Date: Jun. 10, 2010

(54) DISSIMILAR MATERIAL RETENTION

(75) Inventor: Jeffrey C. Robison, Provo, UT (US)

Correspondence Address: SNELL & WILMER L.L.P. (Main), 400 EAST VAN BUREN, ONE ARIZONA CENTER, PHOENIX, AZ, 85004-2202, US

(73) Assignee: CALDERA ENGINEERING, LLC, Provo, UT (US)

(21) Appl. No.: 12/330,561

(22) Filed: Dec. 9, 2008

(51) Int. Cl. F16K 25/00; B21D 51/16

(52) U.S. Cl. 251/368; 29/890.124; 29/890.132

(57) ABSTRACT

In accordance with various aspects of the present invention, methods and apparatuses for designing and configuring dissimilar material retention, specifically a valve plug assembly, are disclosed. The methods and apparatuses enable the application of a wider range of materials in a valve plug assembly than previous valve plug assemblies, and also increase the operational temperature range of the valve plug assembly. In an exemplary embodiment, a valve plug assembly comprises a plug head, a collet surrounding the plug head, a plug base adjacent to the collet, and a retainer surrounding the tapered outside surface of the collet and the plug base, where the plug head extends past the collet and the retainer. The valve plug assembly is configured to create an interference fit of the various components.

### BACKGROUND OF THE INVENTION

Assemblies often are formed by joining two or more objects together. It is often very important that-those assemblies stay joined together throughout the service life of the assembly. Sometimes, however, the materials involved and/or the environmental conditions will not permit the use of glue, adhesives, grout, mortar, solder, brazing, welding, notch/key methods, and similar techniques to adequately hold the assembled objects together.

In these circumstances, an interference fit may be a suitable assembly method to hold the objects together. However, there are various limitations and difficulties that accompany the use of an interference fit. As a specific example, in certain types of valves a ceramic plug head needs to be held firmly to one or more metal components of the valve. Typically, the plug head is retained within the metal component by way of an interference fit. For example, U.S. Pat. No. 6,685,167, (Robison et al.) describes one such valve assembly where a ceramic plug head is retained within a metal plug head band. To accomplish this, the metal plug head band is machined to exacting tolerances and then heated to cause it to expand. The ceramic plug head is then inserted into the metal plug head band, the metal cools and contracts, and an interference fit develops that causes the metal plug head band to grip the ceramic plug head.

Although highly useful, this technique is subject to several limitations and drawbacks. For example, this approach involves a built-in limit on the upper serviceable temperature range for the valve when the materials have different coefficients of thermal expansion because if the operating temperature becomes high enough, the ceramic plug head may drop out of the expanded metal plug head band under service conditions and loading. This maximum operating temperature can be raised by increasing the original interference fit, but doing so also has its own drawbacks. The stresses in the hub and shaft will increase as the interference fit increases. If the interference fit is too great, the hub and/or shaft itself may yield as the assembly cools and the ambient temperature interference is approached. If the hub and/or shaft yields, then the required interference for operating conditions might not be achieved and the shaft could slip under service conditions.

Moreover, the heating process has inherent drawbacks, such as extra work and safety precautions that come with heating the metal plug head band. In addition, the ceramic can be damaged due to thermal shock when hot metal comes in contact with the ceramic plug head. Also, even though differential thermal expansion of the materials may make it possible, it is difficult to replace the ceramic plug head in the field because of the need for a specialized oven to heat the metal assembly to relatively high temperatures to take out the old plug head and insert a new one. Therefore, replacing plug heads for valve plugs is not a typical industry practice for certain combinations of materials or user locations.

Other common difficulties associated with using an interference fit to form an assembly include: the ceramic piece being stuck in the wrong position in the metal piece and subsequent repositioning difficulties; unwanted relative movement between the ceramic and metal pieces during the cooling period; and chipping or cracking of the ceramic piece during assembly.

The above described interference fit also typically involves very high tolerances in the assembly for the purpose of obtaining a specified interference fit at a specified temperature. These exacting tolerances can be, for example, on the order of 5 ten thousandths of an inch (0.0005). Because it is often difficult to manufacture a component, such as a ceramic plug head, with exact dimensions and/or with repeatability, the interference fit of a particular component may involve precision machining of another assembly component to customize the connection.

Thus, it is desirable to overcome some of these and other related limitations associated with interference fit assemblies. This is desirable in not only the context of valves, but in various ceramic/metal interference fit assemblies, and/or in various other interference fit assemblies between a hub and a shaft.

### SUMMARY OF THE INVENTION

In accordance with various aspects of the present invention, methods and apparatuses for designing and configuring dissimilar material retention, specifically a valve plug assembly, are disclosed. The methods and apparatuses disclosed herein enable the application of a wider range of materials in a valve plug assembly than previous valve plug assemblies, and also increase the operational temperature range of the valve plug assembly.

In an exemplary embodiment, a valve plug assembly comprises a plug head, a collet surrounding the plug head, a plug base adjacent to the collet, and a retainer surrounding the tapered outside surface of the collet and the plug base, where the plug head extends past the collet and the retainer. The valve plug assembly is configured to create an interference fit of at least the hub (collet) and shaft (plug head).

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates an exemplary interference fit assembly of a shaft and a hub;

FIG. 2 illustrates an exemplary interference fit assembly of a valve plug assembly;

FIG. 3 illustrates another exemplary interference fit assembly of a valve plug assembly;

FIG. 4 illustrates various exemplary configurations of a valve plug assembly;

FIG. 5 illustrates the expansion forces of an exemplary valve plug assembly;

FIG. 6 illustrates exemplary components in a valve plug assembly;

FIG. 7 illustrates a cut-away view of an exemplary ball valve assembly;

FIG. 8 illustrates a close-up view of an exemplary valve plug assembly gripping a trunnion of a ball valve; and

FIG. 9 illustrates a flowchart of an exemplary method of design of an interference fit between a shaft and a hub.

### DETAILED DESCRIPTION

While exemplary embodiments are described herein in sufficient detail to enable those skilled in the art to practice the invention, it should be understood that other embodiments may be realized and that logical material and mechanical changes may be made without departing from the spirit and scope of the invention. Thus, the following detailed description is presented for purposes of illustration only.

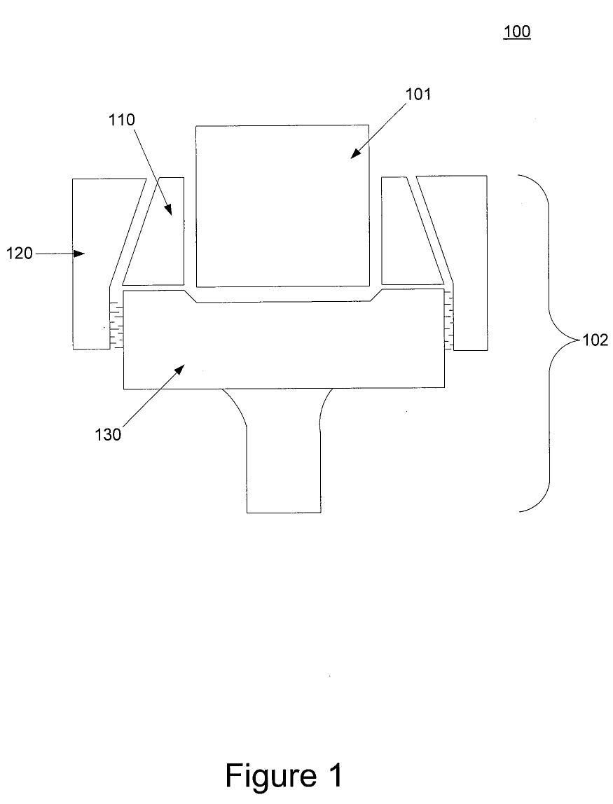

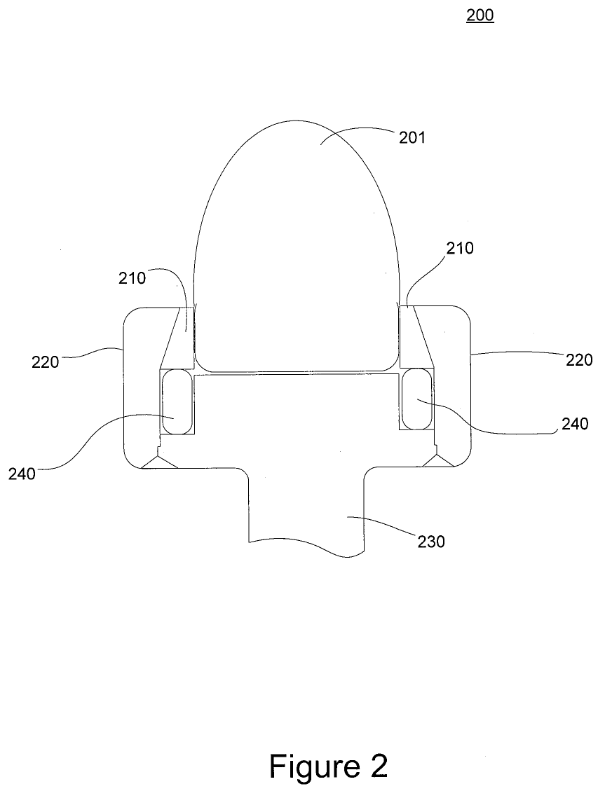

With reference now to FIGS. 1 and 2, in accordance with an exemplary embodiment of the present invention, an assembly 100 is formed by connecting a shaft 101 to a hub 102. In one exemplary embodiment, hub 102 comprises a base component 130, a collet 110, and a collet retainer 120. Although described herein in this manner, it should be appreciated that assembly 100 could also be described from the perspective of shaft 101 being connected to base component 130, wherein the shaft and base component are connected through use of collet 110 and collet retainer 120.

In an exemplary embodiment, assembly 100 is configured to retain shaft 101 in relative fixed position with hub 102 through use of an interference fit. In accordance with an exemplary embodiment, the materials and the geometries of one or more of shaft 101 and hub 102 (and/or its subcomponents) are configured to cause the shaft and hub to be held together with an interference fit that is maintained, increased, or decreased as the assembly temperatures change. In one exemplary embodiment, as the temperature of the assembly increases, the assembly is configured such that the interference fit can increase.

Moreover, in accordance with various exemplary embodiments, the materials used are selected such that the coefficient of thermal expansion (CTE) of the materials aids in obtaining a desired interference fit over a wide range of temperatures. In an exemplary embodiment, assembly 100 has an operational temperature range of −350° F. to 2550° F. The operational temperature range of assembly 100 is dependent on the materials in the assembly and the service requirements. Service requirements of assembly 100 include flow control of fluids at a wide range of temperatures and pressures.

It will be appreciated that the number of geometries and materials used to accomplish the objectives described herein are numerous, and that the examples provided herein are merely for sake of illustrating a few of the possible combinations.

In one exemplary embodiment, shaft 101 comprises a ceramic plug head. Although this embodiment will be used in a number of examples herein, shaft 101 may be a trunnion on a ceramic ball valve, any ceramic object that is to be connected to another object using an interference fit, or any object of any material that is to be connected to another object using an interference fit between a shaft and a hub. In general, shaft 101 has a round, circular outer diameter. However, oval, square, hexagonal, and other shapes may be used.

Furthermore, hub 102 may be described herein in an exemplary embodiment as a base component 130, but in other exemplary embodiments, hub 102 may comprise a plug base for a ceramic plug type valve, a trunnion holder for connecting to a trunnion of a ceramic ball valve, or any other type of device of any material that is to be connected to shaft 101 using an interference fit.

In accordance with an exemplary embodiment, collet 110 is a holding device that forms a hub around the shaft and exerts a strong clamping force on a shaft when it is tightened via a tapered outer collar (i.e., collet retainer 120). In an exemplary embodiment, collet 110 comprises a cylindrical or ring like structure. In one exemplary embodiment, collet 110 is configured to slide onto the shaft. In this exemplary embodiment, collet 110 is configured to grip the shaft by initial tightening of collet retainer 120. In another exemplary embodiment, the shaft may initially be retained in place by other structures, such as a lip or shoulder on the hub as described below.

In an exemplary embodiment, collet 110 is formed of a metal, such as titanium, titanium alloys, stainless and high nickel alloys. Nevertheless, depending on the application, collet 110 may be made of any other suitable material, such as for example, plastic, ceramic or glass. Collet 110 may further comprise slits, such as vertical slits in the sides of the collar. The slits may be configured to facilitate expansion/contraction collet 110.

In addition, collet 110 comprises an inner surface configured to grip the shaft. Collet 110 may further comprise a tapered outer surface. The taper may be configured to have the thicker portion be at a first end, or the taper could be at the second end of the collet. In other words, the taper may be configured to taper from fore to aft, or vice versa. Moreover, the taper could exist in both directions. For example, the collet may have an outer surface that widens near the middle of the collet but narrows near the ends of the collet.

The angle of the taper may be from about 1 degree to about 50 degrees, from about 2 degrees to about 40 degrees, or from about 4 degrees to about 35 degrees. Moreover, the taper on the collet may comprise any suitable angle(s). The angle of the collet is related to the gripping force that may develop between the collet and the shaft as the collet and collet retainer move relatively to each other.

Collet retainer 120 comprises an outer collar in contact with collet 110. In this regard, collet retainer comprises an inner surface at a complementary angle to that of the angled surface of collet 110. Collet retainer 120 is thus configured to surround collet 110 and to cause collet 110 to grip the shaft with a strong force when collet retainer 120 constricts the expansion of collet 110. In an exemplary embodiment, collet retainer 120 has a lower CTE than the CTE of collet 110. In an exemplary embodiment, collet retainer 120 may be connected to, for example, base assembly 130. This connection may be made via screws, welding, cotter pin, and/or any other suitable connecting technique.

In accordance with another exemplary embodiment, and with reference to FIG. 2, a plug assembly 200 comprises a plug head 201, a collet 210, a collet retainer 220, and a plug base 230. Plug assembly 200 may further comprise one or more intermediate spacers 240. Intermediate spacers 240 may also be referred to as a compression ring or an expansion ring.

Furthermore, plug assembly 200 includes plug base 230. Plug base 230 may be configured to be attached to a portion of retainer 220. In an exemplary embodiment, plug base 230 further comprises a projected part which is in contact with collet 210. In yet another exemplary embodiment, plug base comprises a projected part that is in contact with collet 210 and a recess that does not connect to plug head 201. In one exemplary embodiment, plug base 230 is connected to retainer 220 using, for example, a screw assembly.

Similar to plug base 230, in an exemplary embodiment, plug head 201 comprises a portion that projects past collet retainer 220. Plug head 201 may be configured to fit within collet 210, with one end of plug head 201 protruding past one end of collet 220. In the various exemplary embodiments illustrated herein, plug head 201 comprises a straight cylindrical cross section along at least the length that is in contact with collet 210. Nevertheless, any structure and/or geometry may be used that is suitable for the purposes described herein. In an exemplary embodiment, plug head 201 may comprise ceramic material, metal, glass, or plastic. Moreover, plug head 201 may comprise any suitable material and/or structure for use in a control-type valve as would be known to one skilled in the art.

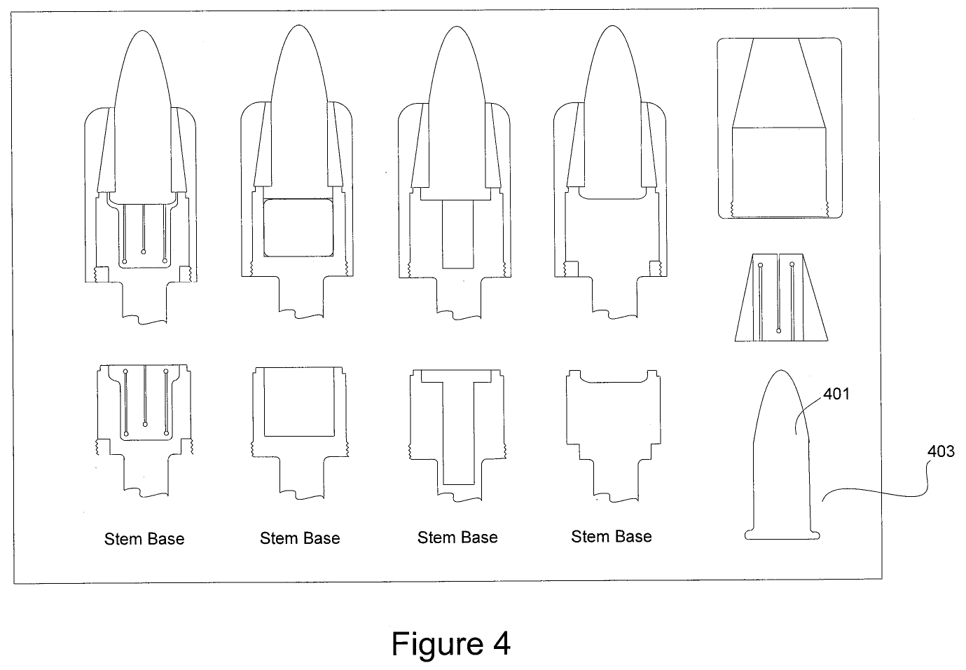

In an exemplary embodiment, and with momentary reference to FIG. 4, a plug head 401 may further comprise a retention shoulder or lip 403 at one end of the plug head. Retention shoulder 403 may be configured to help secure plug head 401 in the plug assembly.

In an exemplary embodiment, the material of the various components of assembly 100 is selected based in part on the coefficient of thermal expansion (CTE) of each component relative to the other components' CTE. Assembly 100 is designed with a geometric layout of the various components such that the different CTE values create a strong, secure assembly with a wide range of operating temperature. The use of selected materials with different CTE values causes a desired grip on plug head 201.

In one embodiment, and with reference to FIG. 2, the CTE of plug base 230 is configured to be higher than the CTE of retainer 220, such that at elevated temperatures, the length of plug base 230 increases more than the length of retainer 220. With the increased length, plug base 230 forces collet 210 against the tapered edge of collet retainer 220 and compresses plug head 201. In another exemplary embodiment, retainer 220 has a lower CTE than at least one of collet 210, plug base 230, and compression ring 240.

In an exemplary embodiment of plug assembly 200, the CTE of plug base 230 and collet 210 is greater than the CTE of collet retainer 220 and plug head 201. Furthermore, the CTE of plug base 230 and collet 210 are equal or substantially similar. In addition, plug base 230 and collet retainer 220 are fixed at their connection point. In an exemplary embodiment, plug base 230 and collet retainer 220 are fixed by at least one of being: screwed on, welded, etc. During assembly, a preload is placed on collet 210, for example by screwing the plug base and the retainer together, that produces an interference fit between collet 210 and plug head 201.

In one exemplary embodiment, the material of plug base 230 is titanium grade 2 and has a CTE in the approximate range of about 5.1 to 5.5 μin/in-° F. Furthermore, the material of collet retainer 220 is zirconium 702 and has a CTE of approximately 3.2 μin/in-° F. The material of collet 210 is titanium grade 2 and has a CTE in the approximate range about 5.1 to 5.5 μin/in-°F. Additionally, the material of plug head 201 is sintered alpha SIC and has a CTE in the approximate range of 2.20 to 2.23 μin/in-° F. Moreover, plug assembly 200 materials may include any suitable materials as would be known to one skilled in the art.

Furthermore, in accordance with an exemplary embodiment, an assembly design is based on the interaction of not only the CTE of the materials, but also the geometric design. Table 1 describes various relationships of how a temperature change can affect a dimension of a component. These various relationships are used to design an assembly with a wide operational temperature range.

TABLE 1
COMPONENT DIMENSIONS AT TEMPERATURE

Change Based on Diameters
Ceramic OD@T = Ceramic OD × (1 + Temperature × CTE)
Retainer ID@T = Retainer ID × (1 + Temperature × CTE)
Collet ID@T = Retainer OD@T − ((Collet OD − Collet ID) ×
(1 + Temperature × CTE))
Interference = Ceramic OD@T − Collet ID@T
Collet Inside Diameter Change Based on Length at a Common Location
Collet L@T = Collet L × (1 + Temperature × CTE)
Retainer L@T = Retainer L × (1 + Temperature × CTE)
Collet ID@T = (Collet L@T − Retainer L@T) × Tangent(Taper Angle)
Collet Inside Diameter Based on Thrust Cylinder
Collet ID@T = ((Thrust Cylinder L × (1 + Temperature × CTE) −
(Stem L × (1 +
Temperature × CTE)) × Tangent(Taper Angle)
Abbreviation Legend

| | |
|---|---|
| ID | inside diameter |
| OD | outside diameter |
| CTE | coefficient of thermal expansion |
| T | temperature |
| L | location of a component at ambient temperature |

Note:
Equations neglect material elastic or plastic deformation

In this exemplary embodiment, when the temperature of exemplary plug assembly 200 increases, the length of plug base 230 will increase relative to the length of collet retainer 220 and the length of collet 210 will increase relative to the length of collet retainer 220. The cross sectional thickness of collet 210 can increase at the same rate or a higher rate than the clearance between the outside diameter of plug head 201 and the adjacent tapered section of collet retainer 220, depending on the CTE of the collet retainer 220, collet 210, and plug head 201. In an exemplary embodiment, the above three relative expansions, alone or in combination, can be utilized to maintain or increase the interference fit between collet 210 and plug head 201 over a broad temperature range of −350° F. to 2550° F.

Since collet retainer 220 has a CTE lower than, or equal to, at least one of the other assembly parts, the retainer can be configured to provide a restraining outside layer when valve plug assembly 200 expands as the temperature increases. The configuration is dependent in part on the physical layout of valve plug assembly 200 and the relationship of the CTE between all the assembly parts. There are multiple factors involved in designing assembly 100. Some of these factors include space between the various components at ambient temperature while maintaining the structure of the assembly, having the components within size tolerances, and thermal expansion to fill the space between the components and tightly constrict the plug head.

To further illustrate, an assembly may be designed with more space between components at ambient temperature if collet retainer 220 has a higher CTE than the plug head because at least part of the assembly expands more from ambient temperature to operating temperature. However, that aspect is looking at the aggregate expansion of the assembly. If one material in the assembly has a high CTE, then the remaining materials may have a low CTE yet achieve the same overall effect, which is tightly gripping a plug head at operating temperature.

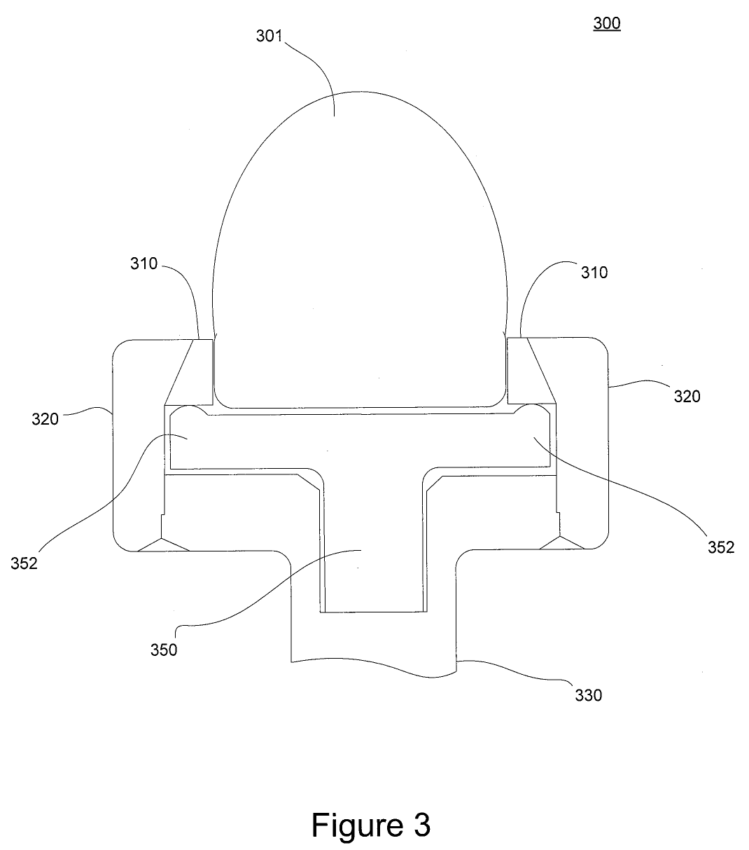

In accordance with an exemplary embodiment and with reference to FIG. 3, a valve plug assembly 300 includes a plug head 301, a collet 310, a plug base 330, a retainer 320, and an expansion ring 350. If the CTE of expansion ring 350 is greater than the CTE of plug base 330, then the tapered collet 310 is forced further into retainer 320. In an exemplary embodiment, this CTE difference is selected to cause an interference fit of valve plug assembly 300 as the larger outside edge 352 of expansion ring 350 expands at an increased rate compared to plug base 330 as the temperature increases.

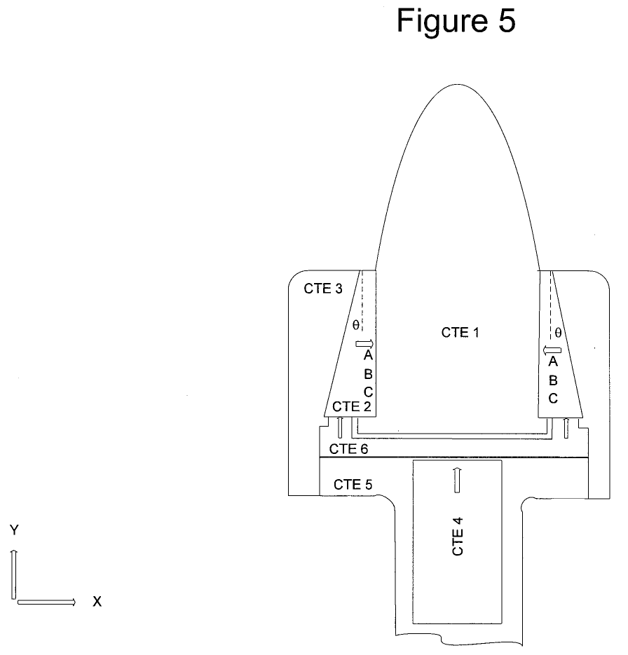

In accordance with an exemplary embodiment and with reference to FIG. 5, a plug head assembly comprises components with six individual CTEs. In the exemplary embodiment and by way of defining the components relationships, CTE 3, CTE 5 and CTE 6 are all equal. Also, CTE 2>CTE 1, and CTE 2>CTE 3. Lastly, CTE 4>CTE 5. If the plug assembly is heated, various compression forces are exerted on the plug head (CTE 1) due to expansion of the components. For example, if the expansion is defined as the change in the y-direction of CTE 4 (Δ CTE_{Y} 4) minus the change in the y-direction of CTE 5 (Δ CTE_{Y} 5), then Interference fit A=tan θ*(Δ CTE_{Y} 4−ΔCTE_{Y} 5). Similarly, if the expansion is defined as the change in the y-direction of CTE 2 (Δ CTE_{Y} 2) minus the change in the y-direction of CTE 3 (Δ CTE_{Y} 3), then interference fit B=tan θ*(Δ CTE_{Y} 2−Δ CTE_{Y} 3). Also exerting force on the plug is expansion of components in the x-direction; namely defining the change in the x-direction of CTE 1, CTE 2, and CTE 3 as Δ CTE_{X} 1, Δ CTE_{X} 2, Δ CTE_{X} 3, respectively. Thus, interference fit C=Δ CTE_{X} 1+Δ CTE_{X} 2−Δ CTE_{X} 3.

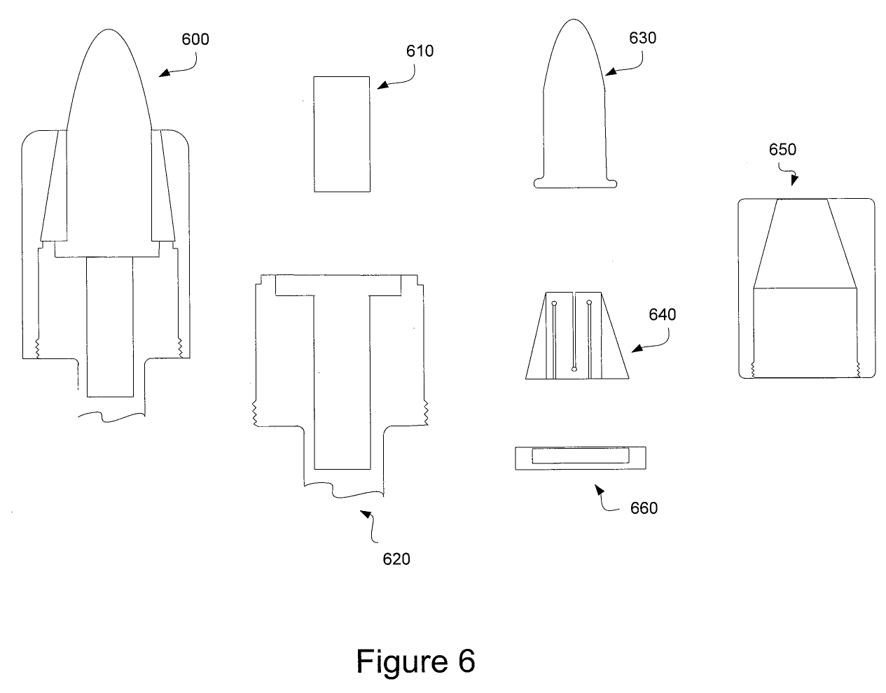

In an exemplary embodiment and with reference to FIG. 6, a valve plug assembly 600 comprising an expansion ring 610, a stem base 620, a plug head 630, a collet 640, a collet retainer 650, and a thrust plate 660. FIG. 6 illustrates one example of the various designs components of valve plug assembly 600 may take, and the overall result of assembly in valve plug assembly 600.

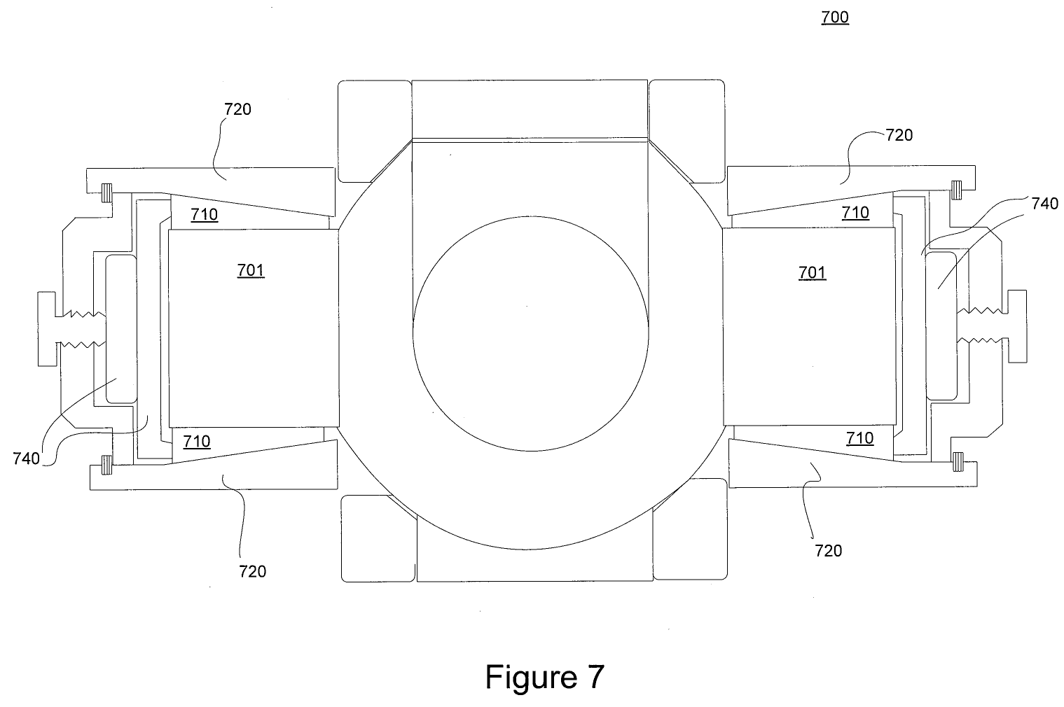

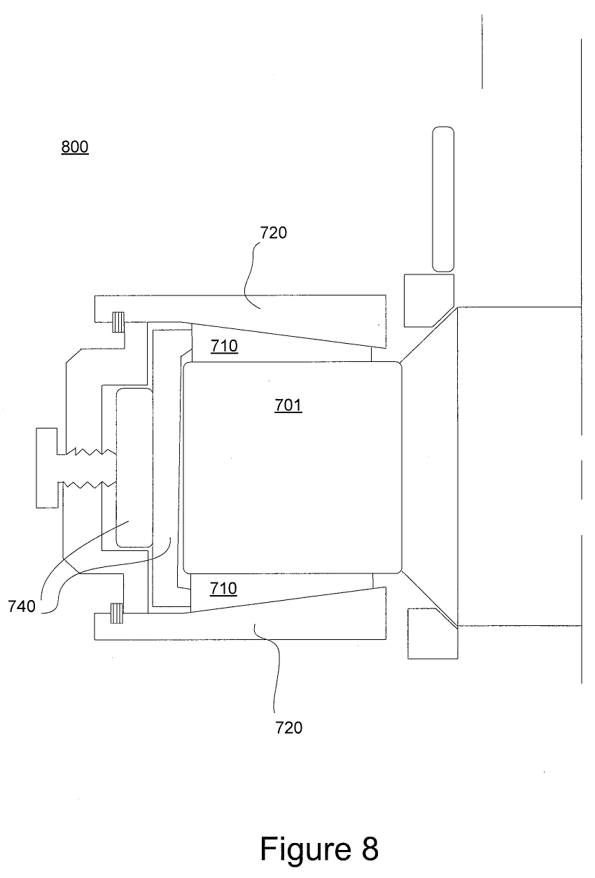

In an exemplary embodiment, the valve plug assembly described above is used in a ball valve assembly with either a single trunnion or a double trunnion. As illustrated in FIGS. 7 and 8, the valve plug assembly is used to securely grip at least one trunnion in order to open or close the ball valve. As illustrated in FIGS. 7 and 8, an exemplary embodiment of a valve plug assembly 700, 800 comprises at least one trunnion 701, a collet 710, a collet retainer 720, and various intermediate spacers 740. As the operating temperature of the ball valve assembly increases, trunnion(s) 701 are constricted with a constant or increasing force, allowing torque to be transmitted from a shaft to one or both trunnions 701.

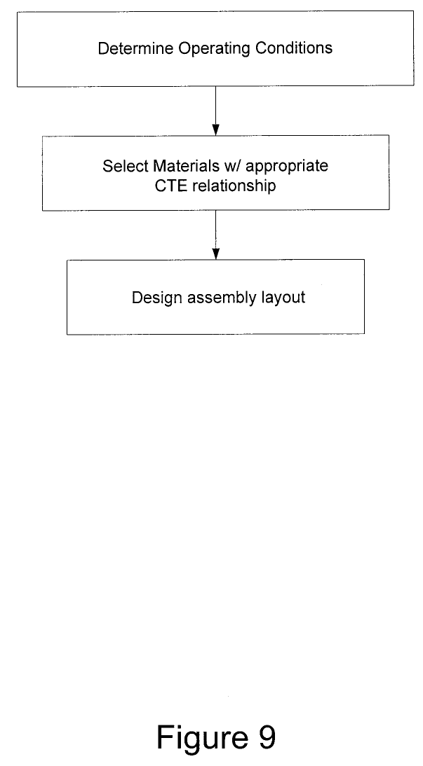

With reference to FIG. 9, an exemplary method of designing an interference fit assembly includes determining the target operating conditions of the assembly, selecting materials with appropriate CTE relationships, and designing an assembly layout. Typically, the interference fit plug design method includes determining how much interference between the plug head and the ring is required at operating temperature in the valve to ensure that the plug head is held securely in place. A determination is also made as to how much interference would exist at ambient temperatures. In many cases, the material used for plug head has a lower CTE than does the interference fit ring. Therefore, the amount of interference is greater between the plug head and the ring at ambient temperature than at operating temperature.

For example, a valve plug might have 0.002″ of diametrical interference between the plug head and the ring at an operating temperature of 300° F. As the plug head cools, the ring shrinks in size relative to the plug head, and at ambient the interference could be 0.007″ for example. The amount of interference between the plug head and the ring is directly related to the amount of assembly stress in a plug head. The amount of interference at ambient temperature becomes a concern when it introduces large stresses in the plug head or other assembly components. It has also been observed that because of these stresses certain valve plugs, head and rings, could not be used because the ambient temperatures or below ambient temperatures, could cause the plug assembly to fail before they could be placed into service.

In accordance with an exemplary design method, determining the target operating conditions includes selecting the temperature range of operation of the interference fit assembly, determining the corrosion impact of the operating environment on a material, and the CTE of various materials. It is also important to determine whether the interference fit of the assembly is desired to increase or remain stable as the operating temperature rises. Based upon the target operating conditions, a material that satisfies the target operating conditions is selected. Typically, the target operating conditions limit the selection of viable materials.

Furthermore, in the exemplary method, designing an assembly layout includes designing the assembly component dimensions and overall assembly dimensions. In the exemplary embodiment, two design factors that facilitate a wide range of variance are the angle between the collet and collet retainer, and the length of the expansion ring. In other words, these two design factors have a substantial effect on the interference fit of the assembly and may effectively be adjusted to compensate for other design properties. After completing an initial design, in an exemplary method, the affect of operation is assessed in terms of the mechanical and material properties of the interference fit assembly. Ideally, an interference fit assembly is able to operate in the target environment with little, or no, material or mechanical damage to the components.

Various exemplary advantages over the prior art, of exemplary embodiments of the present invention, will now be described in further detail. In accordance with various aspects of the present invention, the invention facilitates wider serviceable temperature ranges, improved assembly techniques, improved serviceability, longer service life, reduced failure, improved manufacturing yield and/or the like.

The advantages of an exemplary embodiment are due to a combination of configuring a relationship between the CTE of materials and the geometric layout to control the interference of the materials. The relationship between the CTE of different materials in combination with a geometric design of components can be configured so that the stresses applied to an assembly during operation do not exceed the material properties, thereby increasing the effective temperature range of operation and the useful service life of the assembly.

In one embodiment, dissimilar materials are able to maintain an interference fit at higher temperatures. The serviceable temperature range of an assembly may be increased as compared to assemblies using prior art interference fit techniques. For example, a typical assembly has an operational temperature range of 0° F. to 600° F., while an exemplary embodiment of the present invention has an operational temperature range of −350° F. to 2550° F. In another exemplary embodiment, the assembly has an operational temperature range of 600° F. to 1500° F.

In an exemplary embodiment, the number of different materials that are acceptable for use in a particular application may increase as a result of various aspects of the present invention. A broader range of potential materials is possible due in part to less precise tolerances required. Another aspect increasing the range of potential materials is that the stress/strain in the pre-load interference fit may be lower than that of a prior art interference fit (and in some embodiments may even be zero). Thus, for this reason, new materials may be selected that were not suitable in prior art configurations. The new materials may differ from commonly used materials in that the new materials' properties may be softer, more likely to stretch, less brittle, different heating properties, etc. Thus it may not be necessary to manufacture the new materials to such tight tolerances.

Another advantage is that the need for custom machining of the components to achieve the desired interference fits may be reduced. Some potential materials are expensive to custom machine to a precise tolerance, prohibiting their use in typical prior assemblies. With looser tolerances of component sizes due to the assembly design, the components will be more interchangeable and require less, or no, machining compared to typical prior embodiments. A related advantage is that the need for heating the components for assembly may be reduced or eliminated. In an exemplary embodiment, none, or few, of the components will require expansion from heating prior to assembly.

In addition to increasing the range of potential materials, an exemplary method of assembly design also has manufacturing and assembly advantages. For example, ceramic materials used in the assembly have a reduced chance of being damaged due to thermal shock as the assembly may be assembled at ambient temperature. This also increases the manufacturing yield of the assemblies. Furthermore, in the embodiment assembled at ambient temperature, the ceramic component will be able to be properly placed without the chance of being stuck at the wrong position or changing position because the components are not heated in order to complete the assembly.

In an exemplary embodiment, an advantage of the assembly is on-site component replacement may be facilitated due to the components requiring reduced custom machining and less preheating of components for assembly, in addition to less precise tolerance requirements. In one embodiment, a valve plug assembly may be assembled at ambient temperature. The benefits include not needing special equipment for replacement of a component, as well as making component replacement easier and faster.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “includes,” “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. A method of designing an interference fit assembly, the method comprising:
designing a geometric layout of a first piece, a second piece, and a third piece, wherein said first piece is in contact with and encloses at least a portion of said second piece, and wherein said second piece is in contact with and encloses at least a portion of said third piece;
selecting, for said first piece, a first material with a known CTE;
selecting, for said second piece, a second material with an equal or higher CTE than said first material; and
selecting said first and second material such that the material properties are not exceeded during operation over an operational temperature range.

2. The method of claim 1, further comprising assembling said materials at ambient temperature.

3. The method of claim 1, wherein said operational temperature range is 600° F. to 1500° F.

4. The method of claim 1, wherein said first piece, said second piece, and said third piece are not materially damaged if returned to ambient temperature after operating in said operational temperature range.

5. The method of claim 2, wherein said first piece is a collet retainer, and wherein said second piece is a collet, and wherein said third piece is a plug head.

6. The method of claim 5, wherein said collet retainer, said collet, and said plug head assemble to form a valve plug assembly.

7. The method of claim 1, wherein said third component comprises a ceramic material.

8. An assembly comprising:
a first component comprising a first material with a first CTE; and
a second component comprising a second material with a second CTE, wherein the second CTE is equal to or greater than the first CTE;
wherein a first component is in contact with and encloses at least a portion of said second component, and wherein said second component is in contact with and encloses at least a portion of a third component;
wherein said first component, said second component, and said third component are assembled using an interference fitting.

9. The assembly of claim 8, wherein said assembly operates over a temperature range from −350° F. to 2550° F.

10. The assembly of claim 8, wherein said third component comprises a ceramic material.

11. The assembly of claim 10, wherein the first material is a first metal and the second material is a second metal, and the first metal is different from the second metal.

12. The assembly of claim 8, wherein said first component, said second component, and said third component are assembled at ambient temperature.

13. The assembly of claim 8, wherein said assembly operates over a temperature range from 600° F. to 1500° F.

14. A valve plug assembly comprising:
a plug head;
a collet surrounding said plug head, further comprising a tapered outside surface, a bottom surface, and a length;
a plug base adjacent to the bottom surface of said collet, and further comprising a length; and
a collet retainer surrounding the tapered outside surface of said collet and said plug base, wherein said plug head extends past said collet and said collet retainer;
wherein said valve plug assembly is configured to create an interference fit.

15. The valve plug assembly of claim 14, wherein configuring an interference fit comprises at least one of:
said plug base having a CTE higher than the CTE of said collet retainer, wherein in response to heat, the length of said plug base exceeds the corresponding length of said collet retainer;
said collet having a CTE higher than the CTE of said collet retainer, wherein in response to heat, the length of said collet exceeds the corresponding length of said collet retainer; and
said collet having a CTE the same or higher than the CTE of said collet retainer, wherein in response to heat, the cross sectional thickness of said collet increases at a higher rate than the diameter of said collet retainer.

16. The valve plug assembly of claim 14, wherein said collet further comprises slots to allow for expansion and contraction without exceeding the material properties of said assembly.

17. The valve plug assembly of claim 14, wherein said valve plug assembly is assembled at ambient temperature and the interference fit remains constant or increases as temperature rises.

18. The valve plug assembly of claim 14, wherein said plug head is configured to be replaced at ambient temperature.

19. The valve plug assembly of claim 14, wherein said interference fit, created by said valve plug assembly, is configured to create substantially no pressure at ambient temperature.

20. The valve plug assembly of claim 14, wherein said plug head further comprises a plug head lip.
